(19) United States
(12) Patent Application Publication
(10) Pub. No.: US 2006/0003169 A1
(43) Pub. Date: Jan. 5, 2006

(54) Method for metallizing a rubber surface and structure

(76) Inventors: Ping Chuang, Taoyuan Hsien (TW); Lu-Chin Wu, Taoyuan Hsien (TW)

Correspondence Address: PRO-TECHTOR INTERNATIONAL SERVICES, 20775 Norada Court, Saratoga, CA, 95070-3018, US

(21) Appl. No.: 10/883,291

(22) Filed: Jun. 30, 2004

(51) Int. Cl. B32B 1/00

(52) U.S. Cl. 428/425.8

(57) ABSTRACT

A method for applying a metal layer to silicon rubber is described. A polyurethane (PU) primer is applied and cured before application of the metal layer. The metal layer can be applied on a PU-coated silicon rubber material or article by vacuum metallization, chemical plating, electrical plating or physical vapor deposition, and preferably by sputtering. The coated metal layer manufactured by the disclosure herein shows high resistance to thermal and oxidative degradations and also has high resistance to water absorption in the work environment.

### BACKGROUND

1. Field of Invention

The present invention relates to a method for metallizing a rubber surface and a structure thereof. More particularly, the present invention relates to a method and structure for improving rubber surface metallization.

2. Description of Related Art

A rubber material with a metal layer deposited thereon has many functions in an electronic apparatus, such as, for example, providing electric conduction, increasing thermal conductivity, improving electromagnetic radiation interference (EMI) shielding, modifying optical properties and changing an appearance thereof for decorative purposes.

It is inevitable that the resistivity increases and chemical and physical characteristics of a metal layer change with a considerable rate over time when a metal layer is directly deposited on a rubber layer. The result is poor electrical and thermal conductivity, a weakened EMI shielding effect, and even changes in the color and brightness of the appearance of an object.

### SUMMARY

It is therefore an objective of the present invention to provide a method for metallizing a rubber surface and a structure thereof.

In accordance with the foregoing and other objectives of the present invention, a method for applying a metal layer to silicon rubber is described. A polyurethane (PU) primer is applied and cured before application of the metal layer. The metal layer can be applied on a PU-coated silicon rubber material or article by vacuum metallization, chemical plating, electrical plating or physical vapor deposition, and preferably by sputtering. The coated metal layer manufactured according to the disclosure herein shows high resistance to thermal and oxidative degradations and also has high resistance to water absorption in the work environment.

Thus, the present invention improves not only the as-deposited resistivity of metal layer, but also the durability of the metal layer, which is a critical factor when an object is used for providing electric conduction, increasing thermal conductivity, improving electromagnetic radiation interference (EMI) shielding, modifying optical properties and changing appearances for decorative purposes.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a metallization structure on a rubber surface according to one preferred embodiment of this invention;

FIG. 2 illustrates a chart of resistivities of copper metal layer with different film structures and pretreatment conditions according to one preferred embodiment of this invention;

FIG. 3 illustrates a chart of resistivities of copper metal layer with different film structures and pretreatment conditions according to another preferred embodiment of this invention; and

FIG. 4 illustrates a chart of resistivities of aluminum metal layer with different film structures and pretreatment conditions according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to resolve a problem of increased resistivity and chemical changed composition of a metal layer deposited on a rubber surface, the present invention provides a method to make the metal layer deposited on silicon rubber more durable and comprise excellent metal properties. Thin layers of polyurethane (PU) elastomers are coated on rubbers before application of the metal layer to prevent the degradation of metal layers and maintain the original physical and chemical properties of metal layers.

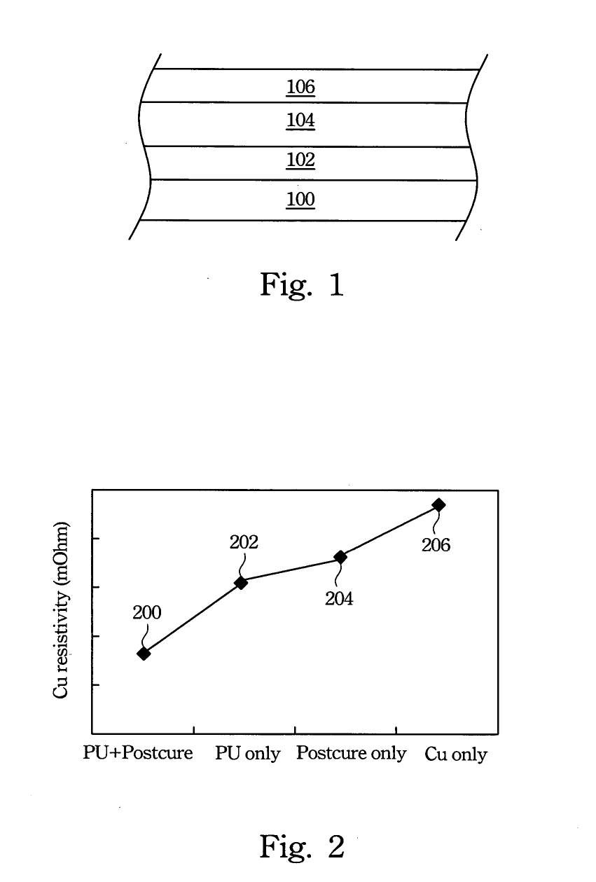

FIG. 1 illustrates a perspective view of a metallization structure on a rubber surface according to one preferred embodiment of this invention. A polyurethane layer 102 is added between a rubber layer 100 and a metal layer 104, when compared with the prior art. Coefficient of thermal expansion (CTE) of a cured polyurethane layer 102 is between CTE of the rubber layer 100 and CTE of the metal layer 104. The polyurethane layer 102 prevents interaction between the rubber layer 100 and the metal layer 104. A thin layer of polyurethane 102 with the same elastic property as the rubber layer 100 may serves as a superior inter layer for buffering the rubber layer 100 and the metal layer 104. Polyurethane layer 102 coheres excellently to silicon rubber, which can also be treated as glue layer between the rubber layer 100 and the metal layer 104. The details of the manufacturing method, including chemical composition of liquid coating PU solutions and the relative process conditions of the thin polyurethane layer 102, is disclosed in U.S. Pat. No. 4,013,806 and the references therein. Modifying the chemical properties of the silicon rubber layer 100 and the polyurethane layer 102 by slightly changing functional groups and relative concentrations of ingredients to improve the interface properties is widely addressed in many patents, such as U.S. Pat. Nos. 6,579,835 and 5,147,725 and the references therein. Typically, thickness of elastic polyurethane layer 102 is 0.1 μm-20 μm with a curing condition 50° C.-170° C. for a period of 0.5-4 hours. The manufacturing method for coating the metal layer 104 can be vacuum metallization, chemical plating, electrical plating or physical vapor deposition, and is preferably sputtering. Moreover, another protection layer 106 is added to the metal layer 104 for other specific demands. This protection layer 106 can be another metal layer coated by vacuum metallization, chemical plating, electrical plating physical vapor deposition, or sputtering or a layer of polymer formed by thermopolymerization or photopolymerization.

FIG. 2 illustrates a chart of resistivities of a copper metal layer with different film structures and pretreatment conditions according to one preferred embodiment of this invention. Point 206 represents a copper layer deposited on bare silicon rubber. Point 204 represents a copper layer deposited on bare silicon rubber with an additional curing process. Point 202 represents a copper layer deposited on a PU-coated silicon rubber. Point 200 represents a copper layer deposited on a PU-coated silicon rubber with an additional curing process. According to FIG. 2, both the additional PU layer and curing process greatly improve the properties and durability of a coated metal layer and the resistivity of deposited copper is only one-third on proper, thermally treated PU-coated silicon rubber substrates compared to that on bare silicon rubber substrates.

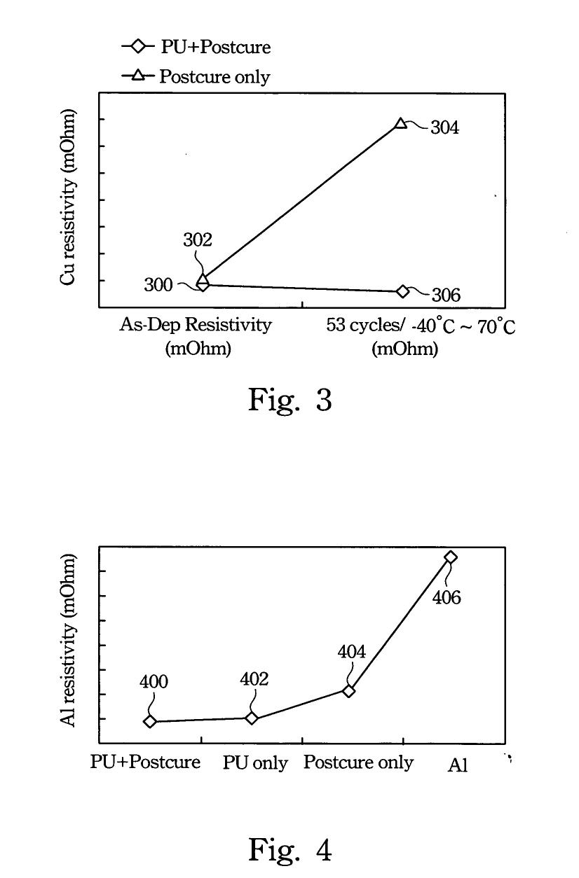

FIG. 3 illustrates a chart of resistivities of copper metal layer with different film structures and pretreatment conditions according to another preferred embodiment of this invention. Point 300 represents a copper layer deposited on bare silicon rubber with an additional curing process. Point 302 represents a copper layer deposited on a PU-coated silicon rubber with an additional curing process. Point 304 represents a copper layer deposited on bare silicon rubber with an additional curing process after 53 thermal cycles (about 90 hours). Point 306 represents a copper layer deposited on a PU-coated silicon rubber with an additional curing process after 53 thermal cycles (about 90 hours). According to FIG. 3, after 53 thermal cycles, the resistivity of copper on the PU-coated rubber remains the same or becomes even lower than the as-deposited resistivity, whereas the resistivity of copper on bare silicon rubber increases sevenfold.

FIG. 4 illustrates a chart of resistivities of aluminum metal layer with different film structures and pretreatment conditions according to one preferred embodiment of this invention. Point 406 represents an aluminum layer deposited on bare silicon rubber. Point 404 represents an aluminum layer deposited on bare silicon rubber with an additional curing process. Point 402 represents an aluminum layer deposited on PU-coated silicon rubber. Point 400 represents an aluminum layer deposited on PU-coated silicon rubber with an additional curing process. According to FIG. 4, both the additional PU layer and curing process greatly improve the properties and durability of a coated metal layer and the resistivity of deposited aluminum layer is almost eightfold on bare silicon rubber compared to that on PU-coated rubbers.

According to the preferred embodiments described above, the present invention improves not only the as-deposited resistivity of metal layer, but also the durability of the metal layer, which is a critical factor when an object is used for providing electric conduction, increasing thermal conductivity, improving electromagnetic radiation interference (EMI) shielding, modifying optical properties and changing an appearance for decorative purposes. Moreover, the coated metal layer manufactured according to the disclosure herein shows high resistance to thermal and oxidative degradation and also has high resistance to water absorption in the work environment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for metallizing a rubber surface, said method comprising:
providing a layer of rubber;
coating a layer of polyurethane on said layer of rubber;
curing and solidifying said layer of polyurethane; and
coating a layer of metal on said layer of polyurethane.

2. The method of claim 1, wherein said layer of rubber is a layer of silicone rubber.

3. The method of claim 1, wherein said layer of metal is coated on said layer of polyurethane by vacuum metallization, chemical plating, electrical plating or physical vapor deposition.

4. The method of claim 1, wherein said layer of metal is coated on said layer of polyurethane by sputtering.

5. The method of claim 1, wherein CTE of said cured layer of polyurethane is between CTE of said layer of rubber and CTE of said layer of metal.

6. The method of claim 1, wherein a thickness of said layer of polyurethane is about 0.1 μm-20 μm.

7. The method of claim 1, wherein said layer of polyurethane is cured at a temperature of about 50° C.-170° C. for a period of 0.5-4 hours.

8. The method of claim 1 further comprising coating another layer of metal on said layer of metal by vacuum metallization, chemical plating, electrical plating, physical vapor deposition or sputtering.

9. The method of claim 1 further comprising coating a layer of polymer by on said layer of metal thermopolymerization or photopolymerization.

10. The method of claim 8 further comprising coating a layer of polymer on said another layer of metal by thermopolymerization or photopolymerization.

11. A metallized surface structure of a rubber article, said metallized surface structure comprising:
a layer of rubber;
a layer of polyurethane, formed on said layer of rubber; and
a layer of metal, formed on said layer of polyurethane.

12. The metallized surface structure of claim 11, wherein said layer of rubber is a layer of silicone rubber.

13. The metallized surface structure of claim 11, wherein said layer of metal is coated on said layer of polyurethane by vacuum metallization, chemical plating, electrical plating or physical vapor deposition.

14. The metallized surface structure of claim 11, wherein said layer of metal is coated on said layer of polyurethane by sputtering.

15. The metallized surface structure of claim 11, wherein CTE of said cured layer of polyurethane is between CTE of said layer of rubber and CTE of said layer of metal.

16. The metallized surface structure of claim 11, wherein a thickness of said layer of polyurethane is about 0.1 μm-20 μm.

17. The metallized surface structure of claim 11 further comprising another layer of metal formed on said layer of metal.

18. The metallized surface structure of claim 11 further comprising a layer of polymer formed on said layer of metal.

19. The metallized surface structure of claim 17 further comprising a layer of polymer formed on said another layer of metal.
